(19) United States
(12) Patent Application Publication
(10) Pub. No.: US 2016/0032821 A1
(43) Pub. Date: Feb. 4, 2016

(54) Six Stroke Internal-Combustion Engine

(71) Applicant: Americar Engine Company, Frisco, TX (US)

(72) Inventor: Karl Louis Dahlstrom, Celina, TX (US)

(73) Assignee: Americar Engine Company, Frisco, TX (US)

(21) Appl. No.: 14/450,781

(22) Filed: Aug. 4, 2014

(51) Int. Cl. F02B 75/02; F02D 13/02

(52) U.S. Cl. CPC F02B 75/021; F02D 13/0203

(57) ABSTRACT

A method for modification and improvement in internal combustion engine systems utilizing six strokes (1. an intake stroke, 2. a compression stroke, 3. a power stroke, 4. an exhaust stroke, 5. an intake-cooling stroke and 6. an exhaust-cooling stroke) and incorporating changes to the camshaft lobes and valve train timing providing for a 3:1 camshaft to crankshaft ratio allowing for higher revolutions per minute, lower idling speeds, reduced valve float and smoother operation. The system provides for more efficient fuel combustion during the power stroke, which extends past bottom dead center thus increasing power, fuel efficiency, and greatly reduces harmful emissions. The additional fifth and sixth strokes provide for intake and exhaust cooling. The system demonstrates increased reliability, efficiency, and a cooler operating environment while operating with various fuels.

### CROSS-REFERENCE TO RELATED APPLICATIONS

This application claims the benefit of U.S. Provisional Application No. 61/958,783, filed Aug. 6, 2013, the disclosure of which is incorporated herein by reference.

### BACKGROUND OF THE INVENTION

It has long been desirable to reduce emissions, increase reliability, increase efficiency, operate with various fuels, and increase power of internal-combustion engines, particularly engines utilized, for example, in industrial, automotive, aviation, marine, utility, recreation and racing industries. The conventional four-stroke internal-combustion engine utilizes a fuel/air intake stroke, a compression stroke, a power stroke, and an exhaust stroke. There are many design limitations with the four-stroke engine such as, for example, valve float at higher crankshaft speeds, exhaust valve overheating, fuel/air detonation at higher compression ratios, contaminating the fuel/air intake with exhaust gases, premature quenching of the combustion stroke, required intake and exhaust valve overlap, higher octane fuels and high peak combustion temperatures and pressures.

U.S. Pat. No. 2,355,806 discloses a type of six-stroke engine in which additional air is introduced and expelled before the traditional four strokes of the four-stroke engine. This design appears to be very similar to the type of six stroke or three cycle system disclosed publicly in the Scientific American Supplement No. 1675, page 85, published on Feb. 8, 1908. The article mainly deals with running and testing of a type of six stroke or three cycle engine and by reference mentions English patent No. 15,898 of a similar engine design. More recently, a type of six-stroke internal-combustion engine is shown and explained in U.S. Pat. No. 4,924,823 which introduces an intake manifold solenoid valve in place of a separate poppet cylinder valve to supply fresh air to the combustion chamber.

U.S. Pat. Nos. 4,809,511 and 4,513,568, assigned to Bajulaz S. A. of Geneva Switzerland, disclose a variation of a six-stroke internal-combustion engine. The engine includes two supplementary fixed-capacity chambers located above each cylinder. The first chamber is a combustion chamber and the second chamber is an air pre-heating chamber. The combustion chamber receives a charge of heated air from the cylinder. Injection of fuel begins an isochoric (constant volume) burn. Such an isochoric burn increases thermal efficiency compared to combustion within the cylinder. The high pressure resulting from the isochoric burn is then released into the cylinder during a power or expansion stroke. At the same time, the air pre-heating chamber has its air contents heated to a high degree by heat passing through the cylinder wall. The heated and pressurized air is used to power an additional stroke of the piston.

U.S. Pat. No. 6,789,513 to Ziabazmi discloses a six-stroke internal-combustion engine with valves that function as both intake and exhaust valves. There is an interval between an exhaust stroke and an intake stroke during which all exhaust gases are expelled completely from a cylinder and a cylinder head before the intake stroke begins. By utilizing every valve in the combustion chamber as an intake and exhaust valve, a volumetric efficiency of the engine is increased.

A well-known six-stroke internal-combustion engine variation is commonly known as the “Crower Engine.” The engine cycle includes injection of water into a cylinder following an expulsion of exhaust gases. Upon entering a hot cylinder, water instantly turns to steam and, thus, expands to approximately 1,600 times its volume. This forces the piston down in the cylinder thereby resulting in an additional power stroke. In addition, injection of water cools the cylinder reducing need for an engine radiator and cooling system. However, the Crower Engine requires a vehicle to have an on-board supply of water. Furthermore, to reduce build-up of contaminants, it is desirable to utilize distilled water. U.S. Pat. No. 4,736,715 to Larsen, U.S. Pat. No. 6,235,745 to Prater, and U.S. Pat. No. 7,021,272 to Singh each disclose variations of the Crower Engine.

Another six-stroke internal-combustion engine design is known as the “Velozeta Engine.” In a Velozeta Engine, air is injected into the cylinder following expulsion of exhaust gases. The air is heated in the cylinder, and thus expands, forcing the piston down for an additional power stroke. The Velozeta Engine can be modified to run on a variety of fuels and has been shown to demonstrate improved fuel consumption, and emissions.

Various other engine designs including, for example, opposed piston designs and barrel block engine designs have been developed and tested.

All of the above said patents and designs retain the normal four-stroke operation as in ordinary engines, and then add two clean-out or scavenging strokes. The exemplary six-stroke engine is a new unique engine design where all six strokes are integrated into one basic and distinct engine configuration and operation.

### SUMMARY OF THE INVENTION

The present invention relates to several improvements in internal-combustion engine systems. In one aspect, the present invention relates to an internal-combustion process having a total of six strokes. The six strokes include 1.) an intake stroke, 2.) a compression stroke, 3.) a power stroke, 4.) an exhaust stroke, 5.) an intake-cooling stroke and 6.) an exhaust-cooling stroke. The internal-combustion engine demonstrates increased reliability, increased efficiency, operates with various fuels, and increases power.

The above-mentioned process is performed by a system whereby a camshaft of the six-stroke internal-combustion engine is provided with an additional lobe or a long-duration lobe that keeps a valve open during three strokes of the complete cycle. The camshaft is rotated at a rate of one-third that of the crankshaft so that one complete cycle or 1,080 degrees is performed for every three revolutions of the crankshaft. Accordingly, the intake stroke and the intake-cooling stroke are accomplished by separate lobes of the camshaft and the exhaust stroke and exhaust-cooling stroke are performed by separate lobes of the exhaust cam. Alternatively, an intake valve may remain open during the intake-cooling, exhaust-cooling, and intake strokes and an exhaust valve may remain open during the exhaust, intake-cooling, and exhaust-cooling strokes by long duration lobes on the camshafts. The internal-combustion engine receives its fuel/air intake charge through a carburetor, through pulsed fuel injection into the intake manifold, or through pulsed fuel injection into the cylinder. A reed valve apparatus may be used to reduce or eliminate reverse flow pulses.

The six-stroke engine design can be adapted to several internal-combustion engine configurations that are presently utilized for four-stroke engines with the following modifications: 1.) The ratio of speed between a crankshaft and camshaft is 3 to 1. 2.) The ignition spark fires once every three revolutions. 3.) The valve opening and closing times are changed or designed as an integrated system to maximize the desired design features and parameters of the invention. 4.) The crankshaft throws may have to be repositioned to maintain even power pulses for maximum smoothness and less vibration while running. 5.) A dual passage intake manifold if a carburetor is utilized.

The combination of the exemplary design features and parameters of the six-stroke engine may result in stratified charging of the combustion chamber, swirling the fuel-air mixture in the combustion chamber, variable valve timing effects, lean burning of fuel air and higher compression ratios. At the same time, a cooler combustion chamber and exhaust valve with a fresh intake fuel-air charge with little or no dilution will promote greater efficiencies, less pollution and emissions, more power with good drive ability in the automotive application, greater reliability, nearly no detonation, less misfiring and minimal pre-ignition.

### BRIEF DESCRIPTION OF THE DRAWINGS

The above mentioned objects and features of the present application may be understood from the drawing figures as described below and the detailed description of the preferred embodiments described further below. The present invention is illustrated in the drawings wherein

FIG. 1A is a vertical sectional view of an internal combustion piston engine according to an exemplary embodiment;

FIG. 1B is a flow diagram illustrating a process for a six-cycle engine, having direct or manifold fuel injection, according to an exemplary embodiment;

FIG. 2 is a cross-sectional view of a camshaft according to an exemplary embodiment;

FIG. 3 is a cross-sectional view of a camshaft according to an exemplary embodiment;

FIG. 4 is a cross-sectional view of a camshaft according to an exemplary embodiment;

FIG. 5 is a cross-sectional bottom view of a cylinder head according to an exemplary embodiment;

FIG. 6 is a cross-sectional bottom view of a cylinder head according to an exemplary embodiment;

FIG. 7 is a cross-sectional bottom view of a cylinder head according to an exemplary embodiment;

FIG. 8 is a cross-sectional bottom view of a cylinder head according to an exemplary embodiment;

FIG. 9 is a cross-sectional bottom view of a cylinder head according to an exemplary embodiment; and

FIG. 10A is a table illustrating experimental data associated with an internal combustion engine according to an exemplary embodiment.

FIG. 10B is a table illustrating experimental data associated with an internal combustion engine according to an exemplary embodiment.

FIG. 11 is a table illustrating experimental data associated with an internal combustion engine according to an exemplary embodiment.

FIG. 12 is a table illustrating experimental data associated with an internal combustion engine according to an exemplary embodiment.

FIG. 13 is a table illustrating experimental data associated with an internal combustion engine according to an exemplary embodiment.

FIG. 14 is a table illustrating experimental data associated with an internal combustion engine according to an exemplary embodiment.

FIG. 15 is a table illustrating experimental data associated with an internal combustion engine according to an exemplary embodiment.

### DETAILED DESCRIPTION OF THE PREFERRED EMBODIMENT

Various embodiments of the present invention will now be described more fully with reference to the accompanying drawings. The invention may, however, be embodied in many different forms and should not be construed as limited to the embodiments set forth herein; rather, the embodiments are provided so that this disclosure will be thorough and complete, and will fully convey the scope of the invention to those skilled in the art.

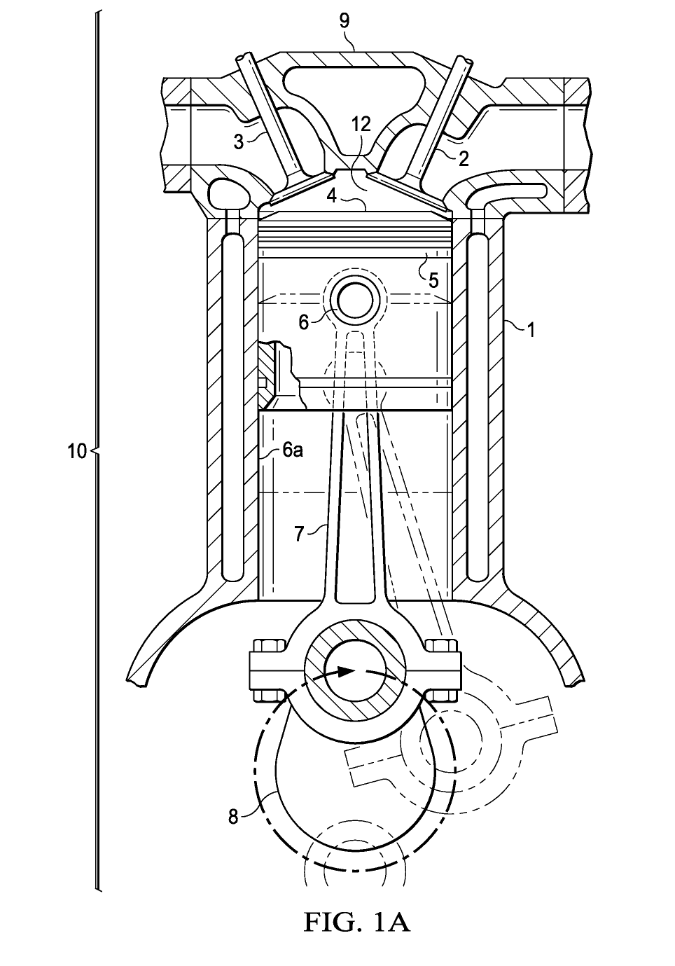

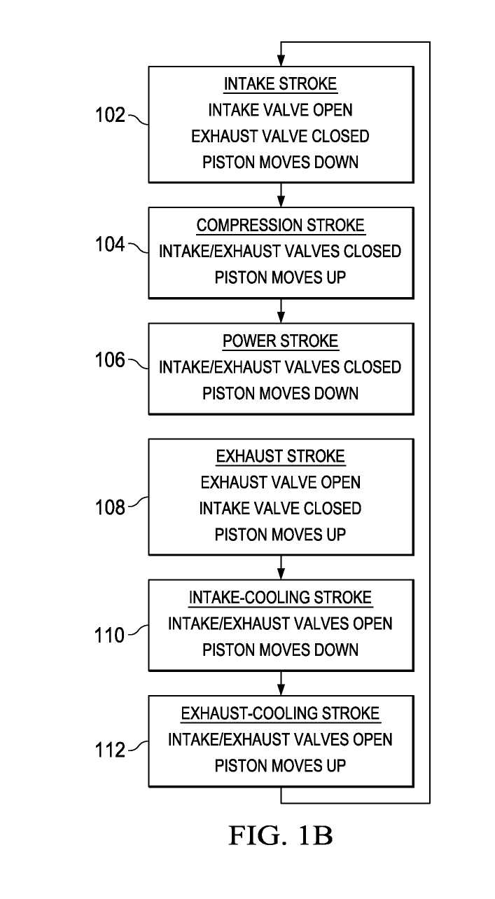

FIG. 1A is a vertical cross-sectional view of an internal-combustion piston engine according to an exemplary embodiment. In a typical embodiment, a six-cycle internal combustion engine 10 includes an engine block 1 having a crankshaft 8 housed therein. The crankshaft 8 is operatively coupled to a connecting rod 7. The connecting rod 7 is operatively coupled to a piston 4 via a wrist pin 6. In a typical embodiment, a plurality of piston rings 5 are disposed about the piston 4. In a typical embodiment, an intake valve 3 is disposed in a cylinder head 9. The intake valve 3 couples an intake passage (“IN”) with a combustion chamber 12. In a typical embodiment, an exhaust valve 2 is also disposed in the cylinder head 9. The exhaust valve 2 couples an exhaust passage (“EX”) with the combustion chamber 12. The intake valve 3 and the exhaust valve 2 may be actuated by, for example, a push rod or a camshaft system utilizing a combination of camshaft lobes. In various embodiments, the camshaft system may include, for example, a single overhead camshaft system or a dual overhead camshaft system. In a typical embodiment, the camshaft system (not explicitly shown) turns at one-third of a speed of the crankshaft 8. A spark ignition system (not explicitly shown) may also be installed when needed which is designed to ignite the mixture on every power stroke.

FIG. 1B is a flow diagram illustrating a process for a six-cycle engine according to an exemplary embodiment. Referring now to FIGS. 1A and 1B, in a typical embodiment, an intake stroke 102 begins when the intake valve 3 opens. The piston 4 moves in a downward direction within the cylinder 6a thereby drawing a mixture of fuel and air into the combustion chamber 1 2. A compression stroke 1 04 begins when the intake valve 3 closes and the piston 4 moves in an upward direction thereby compressing the fuel/air mixture within the combustion chamber 12. Both the intake valve 3 and the exhaust valve 2 are closed during the compression stroke 104. A power stroke 106 begins when the fuel/air mixture is ignited by, for example, a spark plug. Combustion of the fuel/air mixture forces the piston 4 to move in a downward direction. Both the intake valve 3 and the exhaust valve 2 are closed during the power stroke 106. An exhaust stroke 108 begins when the exhaust valve 2 opens. The piston 4 moves in an upward direction thereby expelling exhaust gases from the combustion chamber 12. The intake valve 3 remains closed during the exhaust stroke 108.

Still referring to FIGS. 1A and 1B, in a typical embodiment, both the intake valve 3 and the exhaust valve 2 are open during the cooling-intake stroke 110. The piston 4 moves in a downward direction thereby drawing air through the intake valve 3 into the combustion chamber 12. In addition, residual exhaust gases are drawn through the exhaust valve 2 into the combustion chamber 12. The air and the residual exhaust gases are at a substantially lower temperature than the combustion chamber 12. Thus, the cooling-intake stroke 110 serves to cool the combustion chamber 12. Such cooling of the combustion chamber lessens the possibility of premature ignition of fuel and allows for high compression ratios and leaner fuel/air mixtures. A cooling-exhaust stroke 112 begins when the intake valve 3 and the exhaust valve 2 open and the piston 4 begins moving in an upward direction thereby expelling air and residual exhaust gases from the combustion chamber 12. After completion of the cooling-exhaust stroke 112, the exhaust valve 2 closes and the intake valve 3 remains open thereby starting the intake stroke 102.

Thus, the intake-cooling stroke 110 and the exhaust-cooling stroke 112 cool the combustion chamber 12 and the exhaust valves 2 by introducing an air charge after the power stroke 108 and exhausting the air charge. In various embodiments, the intake valve 3 may remain open during the intake-cooling stroke 110 to create an air flow from the open intake valve 3 to an open exhaust valve 2 causing additional cooling of the combustion chamber 12 and the exhaust valve 2. Cooling the combustion chamber 12 and the exhaust valve 2 allows the compression ratio to be greatly increased and the ignition spark timing to be advanced without detonation or pre-ignition. In lieu of increasing the compression ratio and/or the ignition spark advance, lower octane fuels can be successfully utilized without detonation or pre-ignition.

In a various embodiments, the six-stroke internal-combustion engine 10 may include one or multiple cylinders. The six-stroke internal-combustion engine 10 reduces emissions, increases reliability, increases efficiency and operates with various fuels whether utilizing a throttle body (fuel injection); supercharging or turbocharging; low pressure forced air induction; pulsed direct or port fuel injection with or without supercharging or turbocharging; or with or without low pressure force air induction. In various embodiments, the six-stroke internal-combustion engine 10 may include two through five valves per cylinder; push-rods, single or dual overhead camshaft mechanisms; single or dual intake manifolds; delayed or advanced intake valve openings; delayed or advanced exhaust valve openings; in various combinations. Several design parameters and variables that affect the combustion process can be adjusted to produce a near perfect and uniform combustion environment inside the combustion chamber. Such a uniform combustion environment reduces or nearly eliminates unburned hydrocarbons (HC), carbon monoxide (CO), oxides of nitrogen (NOx), particulate and soot exhaust emissions, decrease fuel consumption, and allow the use of many types of fuels from low-grade blends to hydrogen. A uniform combustion environment also increases torque and produces more power while at the same time eliminating most of the detrimental effects of operating an internal-combustion engine at full power over an extended period of time.

Still referring to FIGS. 1A and 1B the six-stroke internal-combustion engine 10, according to an exemplary embodiment, provides for a higher compression ratio than can be used in a four-stroke engine. Such a higher compression ratio results in fewer detonation and pre-ignition problems while burning the same octane fuel as used in a four-stroke engine. For example, a four-stroke engine burning a 64 octane fuel would require a compression ratio no higher than 7.0 to 1, but a six-stroke engine burning a 64 octane fuel would require a compression ratio no higher than 10.5 to 1. An engine operating with a 10.5 to 1 compression ratio instead of 7.0 to 1 compression ratio would result in greater efficiency and increased power.

Still referring to FIGS. 1A and 1B, the six-stroke internal-combustion engine 10, according to an exemplary embodiment, provides for staggered or phased opening and closing of the intake valve 3 which thereby causes the fuel/air mixture in each cylinder to be stratified. Such stratification results in richer fuel/air mixture being located at a top of the cylinder near the spark plug and leaner fuel/air mixture being located at a bottom of the cylinder near the top of the piston. In addition, the six-cycle internal-combustion engine provides for the opening of the exhaust valves later during the power stroke at a piston 4 position of near or past bottom dead center (BDC) allowing longer burn time creating less peak pressures and temperatures with reduced emissions, increased efficiency and increased power.

Still referring to FIGS. 1A and 1B, the six-stroke internal-combustion engine 10, according to an exemplary embodiment, provides for a gap, down to zero gap, between closing of the exhaust valve 2 and opening of the intake valve 3. In a typical embodiment, the exhaust valve 2 may close near to or before top dead center (BTDC) during the cooling-exhaust stroke 112 and the intake valve may open near to or after top dead center (ATDC) during the intake stroke 102. The small overlap or gap between closing of the exhaust valve 2 and opening of the intake valve 3 causes less exhaust gas dilution thereby decreasing emissions, increasing efficiency and increasing power and torque during lower speed operation of the six-stroke internal-combustion engine 10.

Still referring to FIGS. 1A and 1B, the six-cycle internal-combustion engine 10, according to an exemplary embodiment, provides for a fresh charge of fuel/air mixture during the intake stroke 1 02 with little or no dilution or contamination with exhaust gases. This fresh charge of fuel/air mixture will burn more completely, evenly and efficiently with less detonation, pre-ignition, quenching and ignition misfires resulting in less emissions, greater overall efficiency and power with greater reliability.

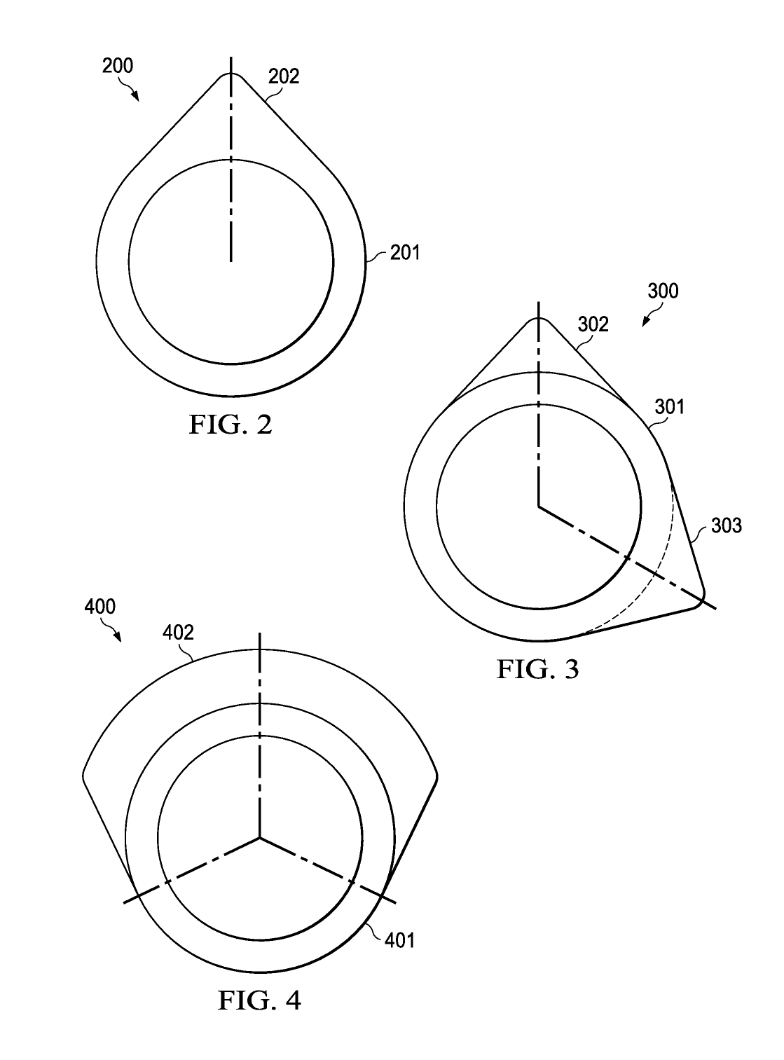

FIG. 2 is a cross-sectional view of a camshaft and a single lobe according to an exemplary embodiment. In a typical embodiment, a camshaft 200 includes a base circle 201 and a single lobe 202. In a typical embodiment, the lobe 202 is utilized with the intake valve 3 (shown in FIG. 1A) which communicates with a carburetor (not explicitly shown). This lobe opens the intake fuel-air valve during the intake cooling stroke 110.

FIG. 3 is a cross-sectional view of a camshaft having dual lobes according to an exemplary embodiment. In a typical embodiment, a camshaft 300 includes a base circle 301, a first lobe 302 and a second lobe 303. In a typical embodiment, the camshaft turns counter-clockwise. The first lobe 302 opens the intake valve 3 (shown in FIG. 1A) during the intake stroke 102. The second lobe 303 opens the intake valve 3 during the intake-cooling stroke 110. In other embodiments, the first lobe 302 may be utilized to open the exhaust valve 2 during the exhaust stroke 108 and the second lobe 303 could be utilized to opens the exhaust valve 2 during the intake-cooling stroke 110.

FIG. 4 is a cross sectional view of a camshaft and long duration lobe according to an exemplary embodiment. In a typical embodiment, a camshaft 400 includes a lobe profile comprising of a base circle 401 and an extended lobe 402 that is utilized with the air intake manifold and opens the intake valve 3 (shown in FIG. 1A) during the intake-cooling stroke 110, the exhaust-cooling stroke 112, and the intake stroke 102. The extended lobe 402 could also be utilized with the exhaust manifold (EX) (shown in FIG. 1A) to open the exhaust valve 2 during the exhaust stroke 108, the intake cooling stroke 110, and the exhaust-cooling stroke 112.

Thus, the camshafts 300 and 400 are fabricated to allow for single or multiple valve openings per revolution, with up to two lobes and/or a long duration lobe actuating the intake valve 3 and the exhaust valve 2. For example, a single lobe may actuate the fuel/air intake valve and two lobes actuate the air intake valve for a carbureted engine or two lobes actuate the fuel/air intake valve or valves for pulsed direct or port fuel injection with or without supercharging or turbocharging or low pressure forced air induction. A single long-duration lobe such as, for example, the extended lobe 402, allows the exhaust valve 2 to remain open during the exhaust stroke 108, the intake cooling stroke 110, and the exhaust-cooling stroke 112. The intake valve 3 remains open during the intake-cooling stroke 110, the exhaust-cooling stroke 112, and the intake stroke 102 for pulsed direct or port fuel injection with supercharging or turbocharging or low pressure forced air induction. The single, multiple or long duration lobes may be used in different other combinations.

Referring now to FIGS. 2-4, the camshaft, such as for example the camshafts 200, 300, or 400, is timed such that a three to one ratio exists between the camshaft speed and the crankshaft speed. Such a ratio allows the camshaft to turn at a slower speed in relationship to crankshaft speed. Such a ratio results in better valve train control and less valve float at higher engine speeds than a four-stroke engine.

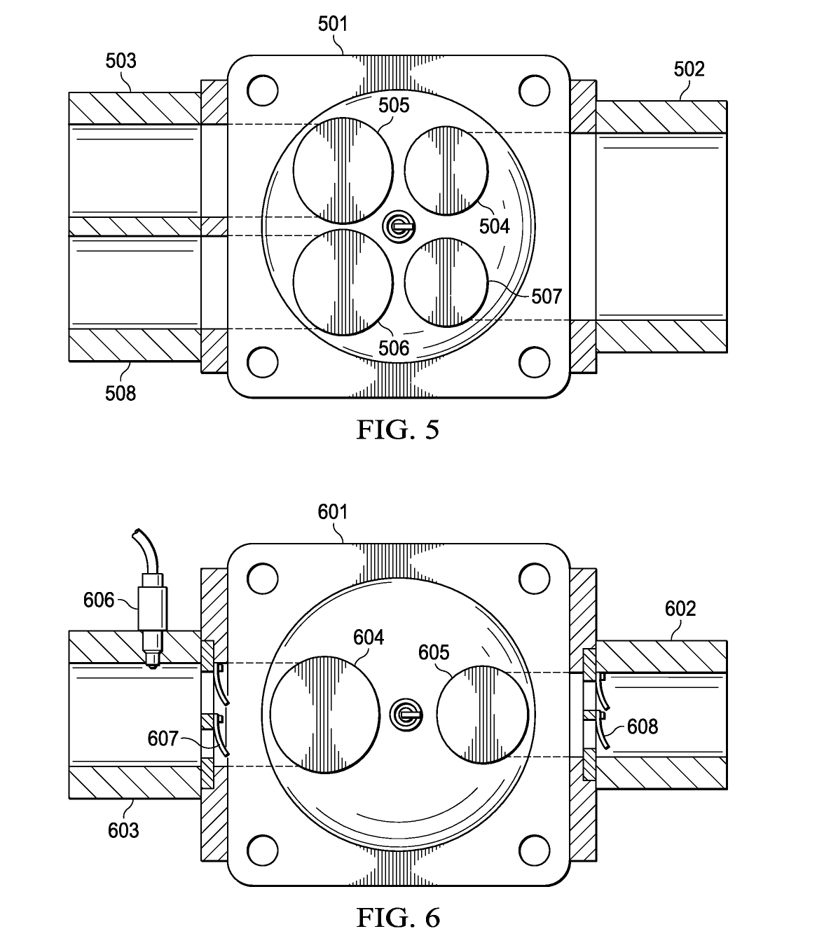

FIG. 5 is a cross sectional bottom view of the cylinder head according to an exemplary embodiment. In a typical embodiment, a cylinder head 501 includes a first intake valve 505 which communicates with an intake-air manifold 503 and a second intake valve 506 which communicates with intake fuel-air manifold 508 and a carburetor (not explicitly shown). A first exhaust valve 504 and a second exhaust valve 507 communicate with an exhaust manifold 502. A camshaft such as, for example, the camshafts shown in FIGS. 2, 3 and 4, may be used to open and close the first and second intake valves 505, 506 and the first and second exhaust valves 504, 507 as determined by the application of the engine.

FIG. 6 is a cross-sectional bottom view of a cylinder head according to an exemplary embodiment. In a typical embodiment, a cylinder head 601 includes an intake valve 604 which communicates with an intake air manifold 603 and an exhaust valve 605 which communicates with an exhaust manifold 602. A pulsed fuel injector 606 is installed in the intake air manifold 603 near the intake valve 604. In other embodiments, a first reed valve apparatus 607 may be installed close to the intake valve 604 and a second reed valve apparatus 608 is located close to the exhaust valve 605 to restrict or eliminate any back flow or pressure. A camshaft such as, for example, the camshafts shown in FIGS. 2, 3 and 4 may be used to open and close the intake valve 604 and the exhaust valve 605 as determined by the application of the engine.

Thus, the reed-valve apparatus 608 restricts or eliminates back flow or pressure in the intake manifold 603 and the exhaust manifold 602. For example, the reed-valve apparatus 608 may be any device that only allows gaseous flow in one direction. In the intake manifold 603, the reed valve apparatus 608 may be positioned to allow flow from the intake manifold 603 into the combustion chamber. In the exhaust manifold 602, the reed valve apparatus 608 would be positioned to allow flow from the combustion chamber into the exhaust manifold 602. The reed valve apparatus 608 may be used when valve timing of intake and exhaust is overlapped or extended in certain combinations and applications.

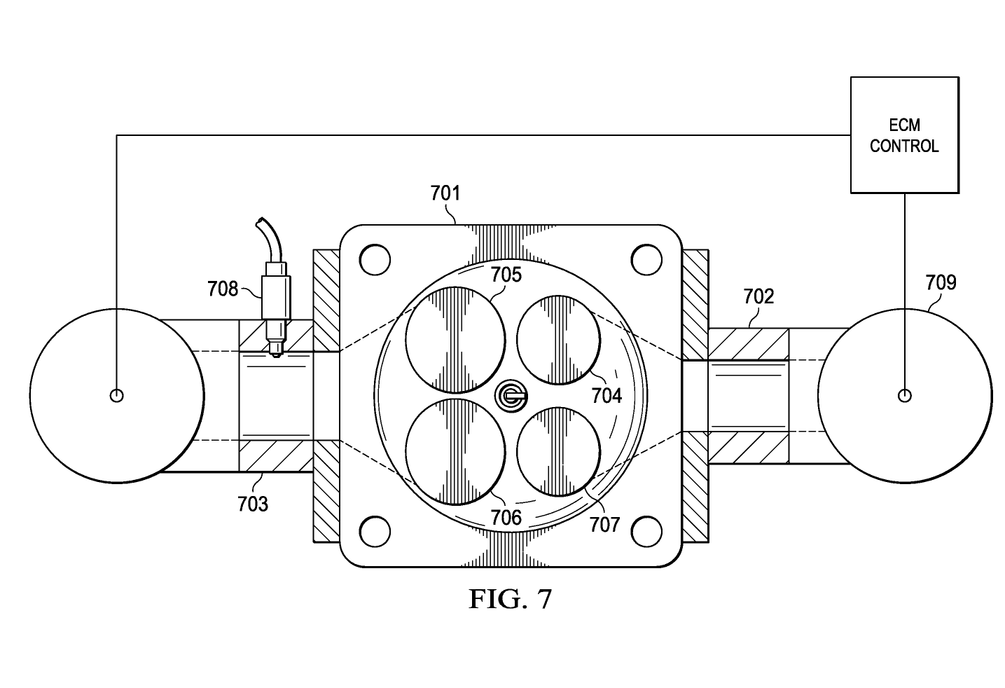

FIG. 7 is a cross-sectional bottom view of a cylinder head according to an exemplary embodiment. In a typical embodiment, a cylinder head 701 includes a first intake valve 705 which communicates with an intake-air manifold 703 and a second intake valve 706 which also communicates with the intake-air manifold 703. A first exhaust valve 704 and a second exhaust valve 707 communicate with an exhaust manifold 702. A camshaft such as, for example, the camshafts shown in FIGS. 2, 3 and 4 may be used to open and close the first and second intake valves 705, 706 and the first and second exhaust valves 704, 707 as determined by the application of the engine. In other embodiments, a turbocharger 709 may be installed with an exhaust turbine (not explicitly shown) located in the exhaust manifold 702 and an intake boost turbine (not explicitly shown) located in the intake manifold 703. A common shaft from exhaust turbine drives the intake boost turbine. In other embodiments, a low pressure forced air fan may be used in the induction system to provide for a differential pressure between the intake side and exhaust side of the fuel/air system without producing any excess heat as would be common with a turbocharging or supercharging system. In a typical embodiment, a pulsed fuel injector 708 is installed in the Intake manifold 703 near the first intake valve 705.

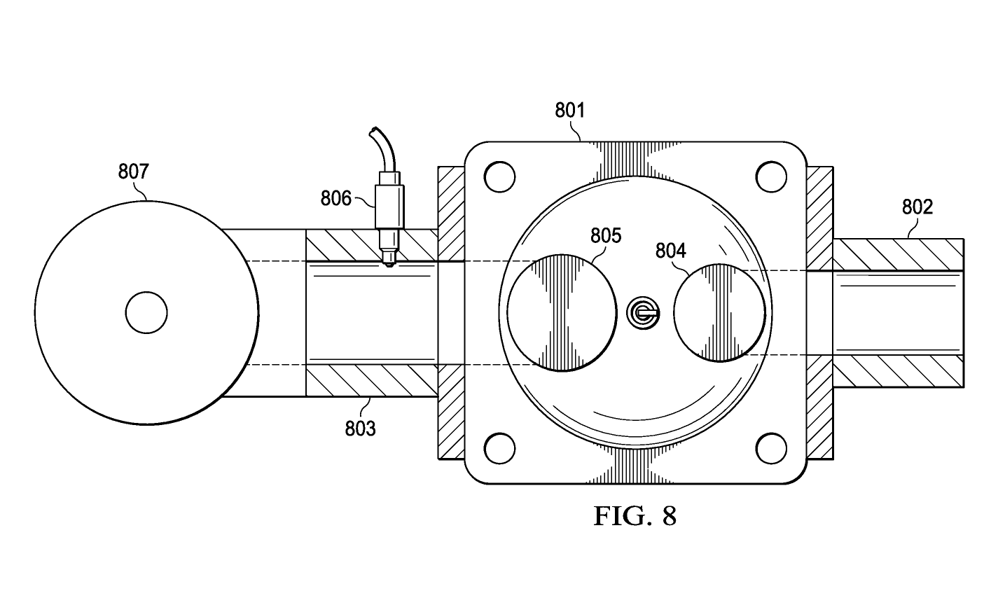

FIG. 8 is a cross-sectional bottom view of a cylinder head according to an exemplary embodiment. In a typical embodiment, a cylinder head 801 includes an intake valve 805 which communicates with an intake-air manifold 803 and an exhaust valve 804 which communicates with an exhaust manifold 802. In a typical embodiment, a pulsed fuel injector 806 is installed in the intake-air manifold 803 near the intake valve 805. In other embodiments, a supercharger 807 may be installed in the intake-air manifold 803 to create a boost in pressure in the intake-air manifold 803. A camshaft such as, for example, the camshafts shown in FIGS. 2, 3 and 4 may be used to open and close the intake valve 805 and the exhaust valve 804 as determined by the application of the engine.

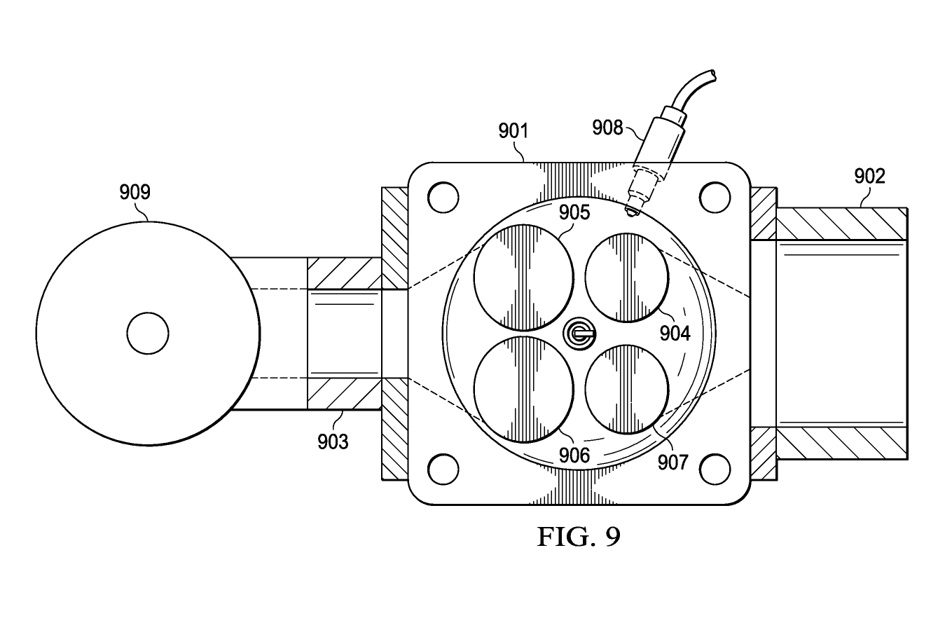

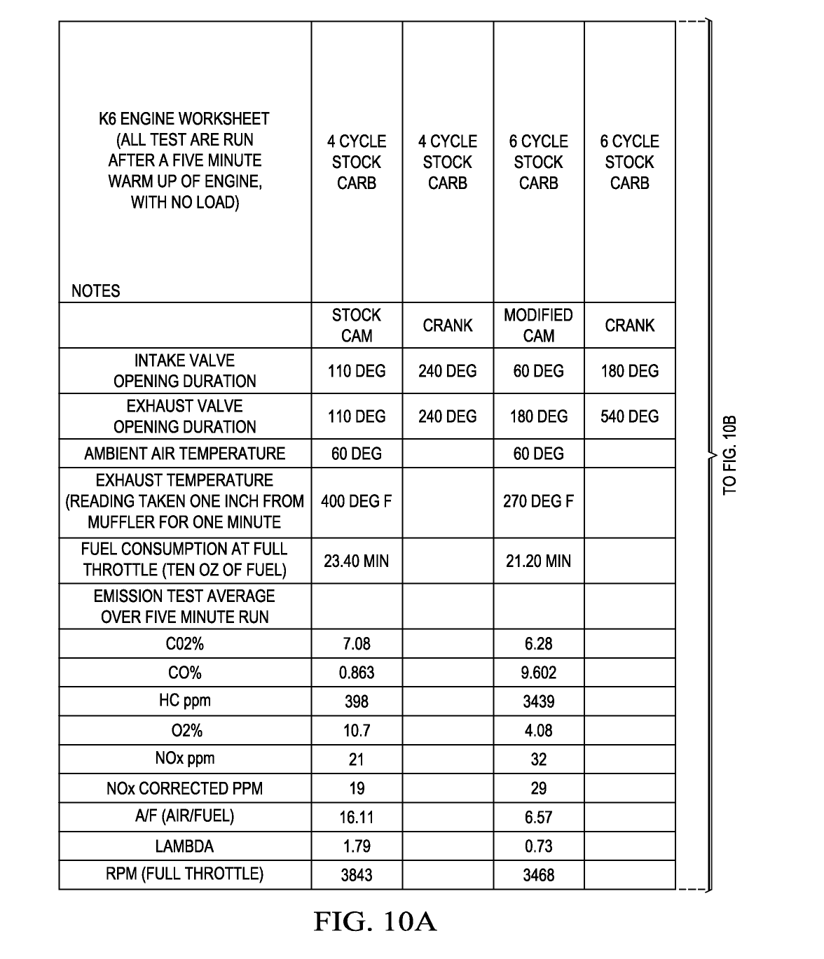

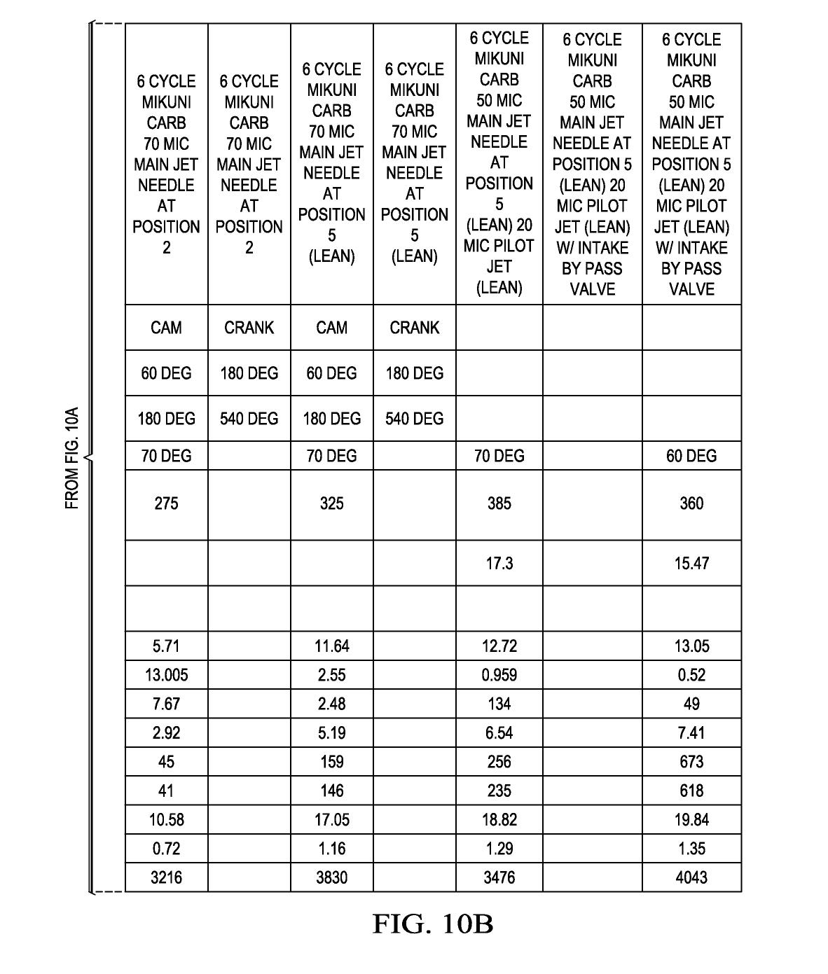

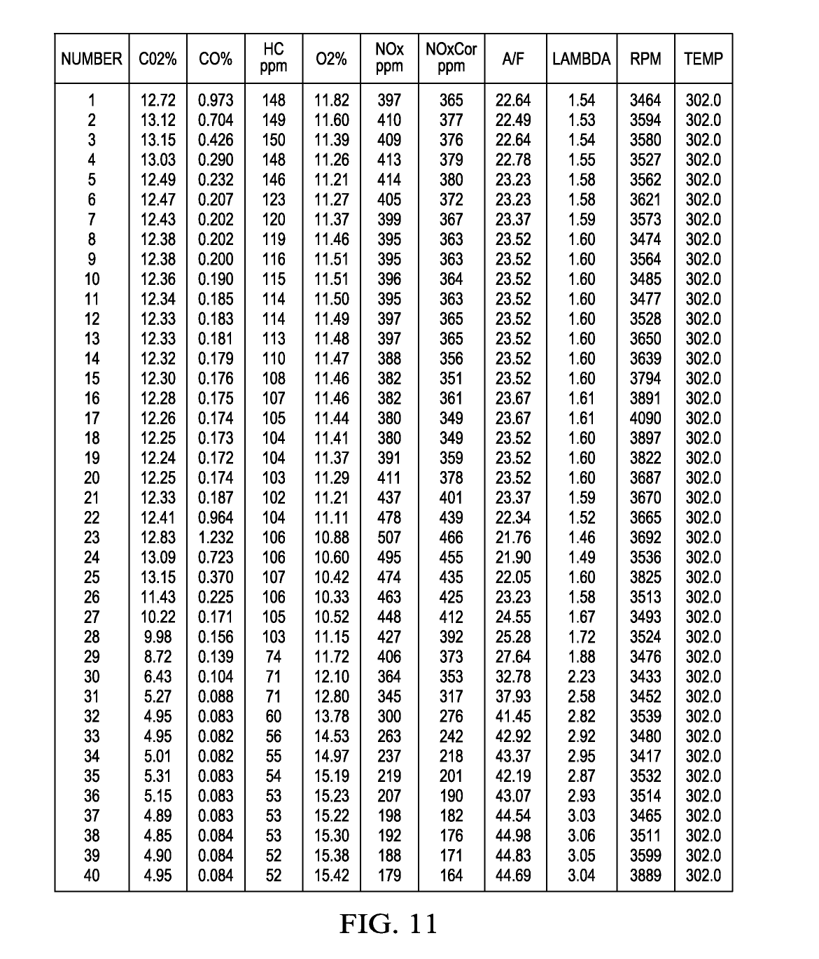

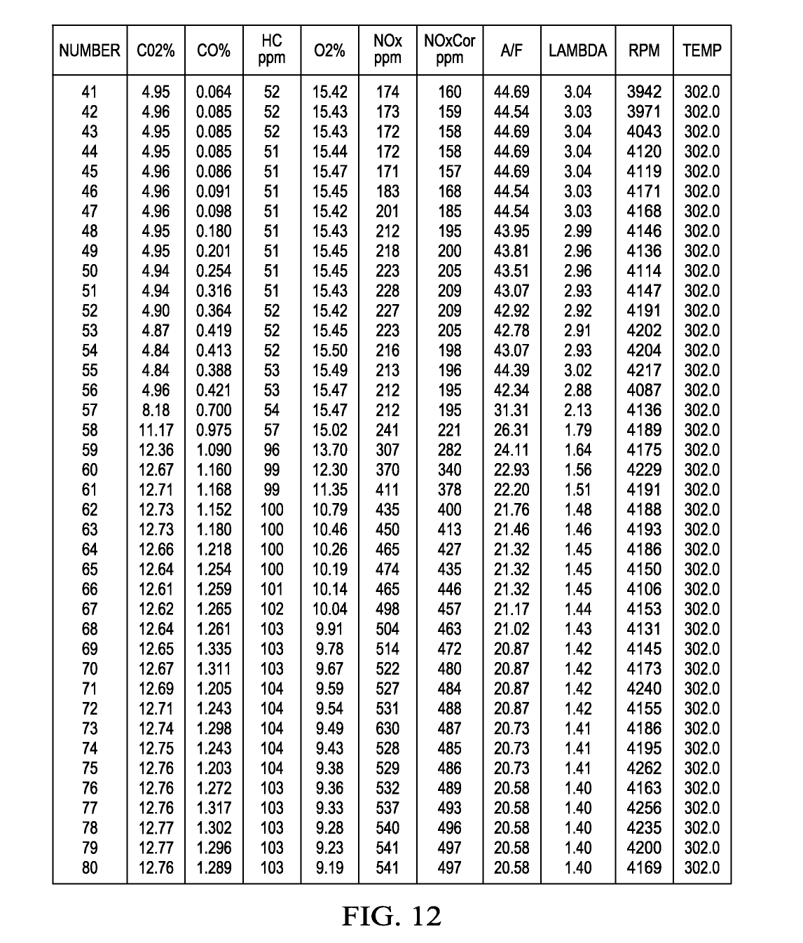

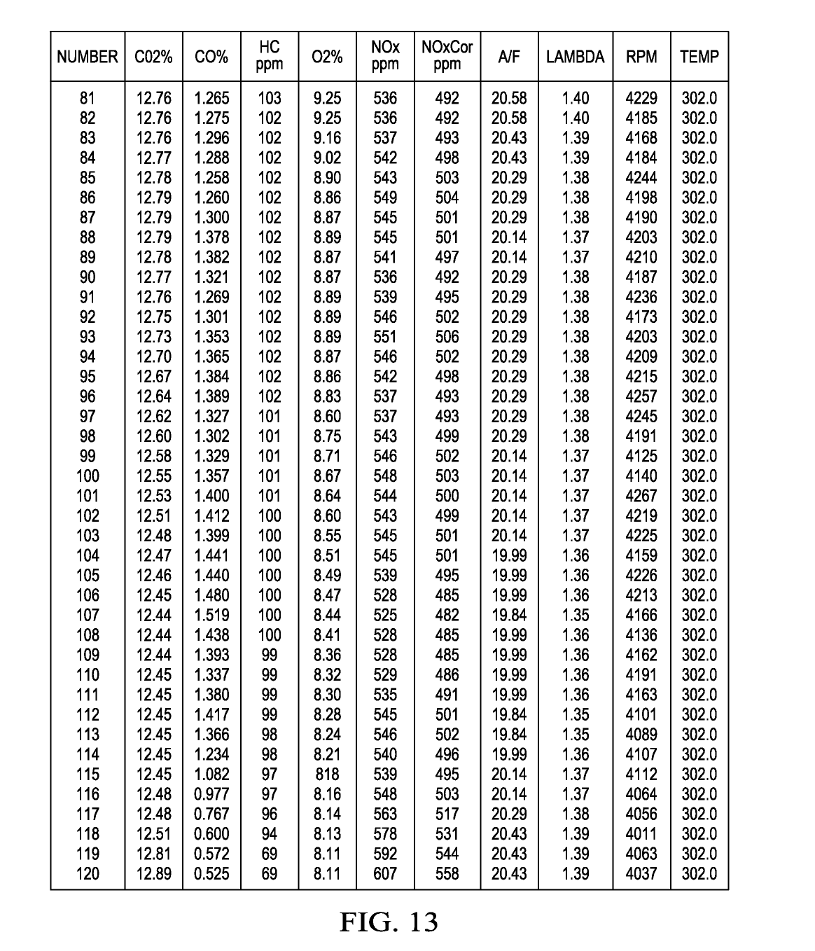

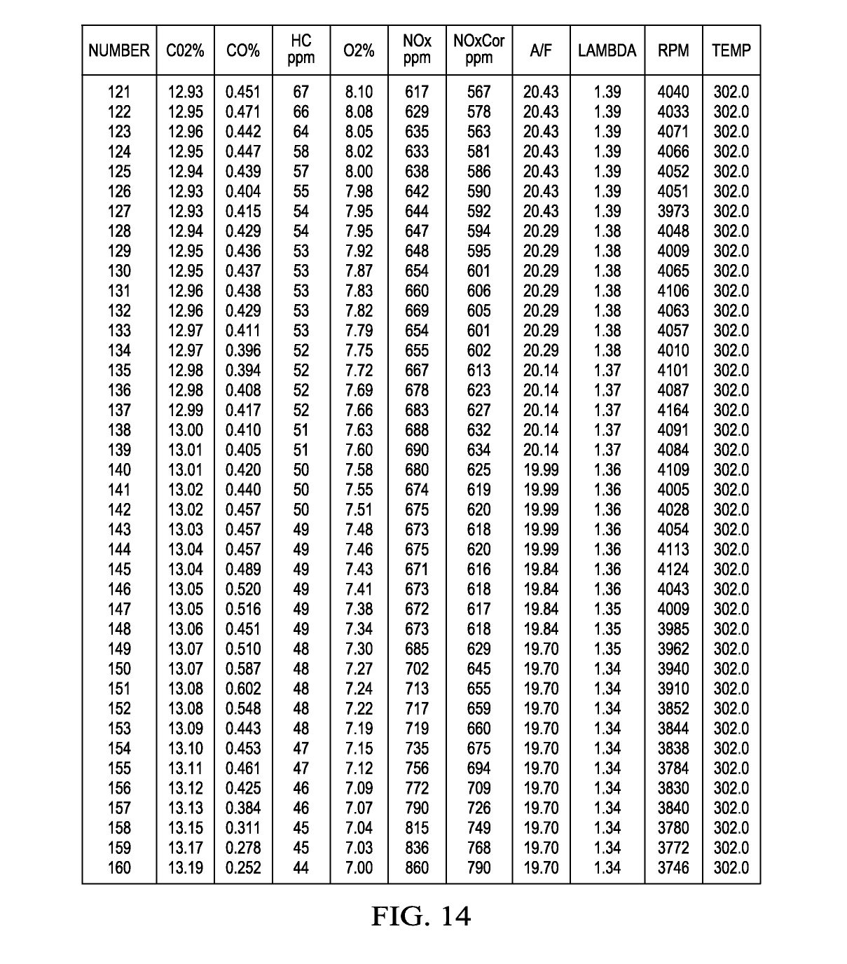

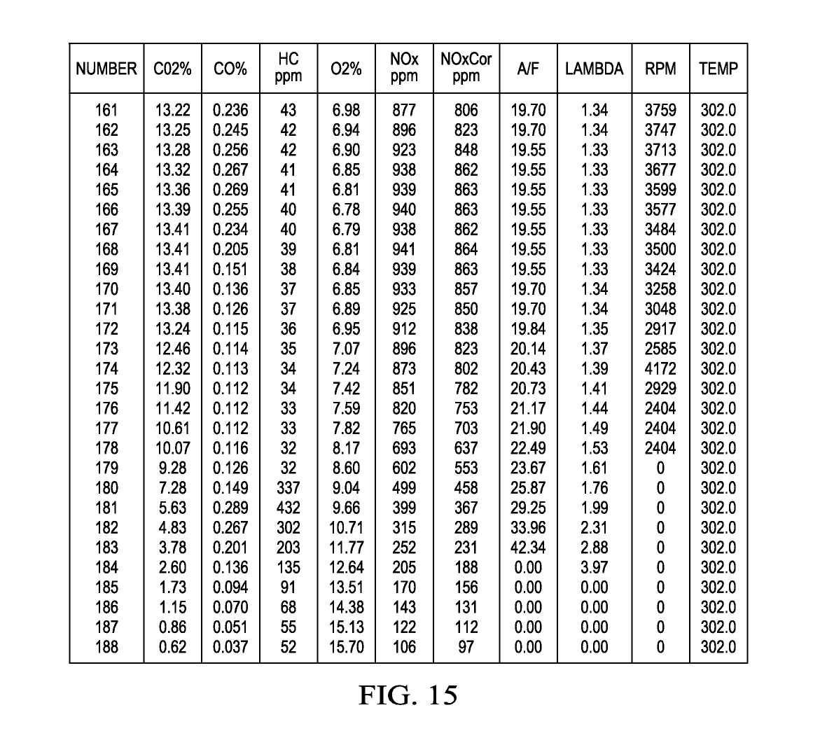

FIG. 9 is a cross-sectional bottom view of a cylinder head according to an exemplary embodiment. In a typical embodiment, a cylinder head 901 includes a first intake valve 905 which communicates with an intake-air manifold 903 and a second intake valve 906 which also communicates with the intake-air manifold 903. A first exhaust valve 904 and a second exhaust valve 907 communicate with an exhaust manifold 902. A camshaft such as, for example, the camshafts shown in FIGS. 2, 3 and 4 may be used to open and close the first and second intake valves 905, 906 and the first and second exhaust valves 904, 907 as determined by the application of the engine. In a typical embodiment, a direct-pulsed fuel injector 908 is installed in the cylinder head 901 to inject fuel directly into a combustion chamber 12 (shown in FIG. 1A). In other embodiments, a supercharger 909 may be installed in the intake manifold 903.

Appendix A is a table illustrating experimental data associated with an internal-combustion engine according to an exemplary embodiment. As shown in Appendix A, the six-stroke internal-combustion engine 10 exhibits lower emissions of pollutants such as, for example, carbon dioxide (C02) and carbon monoxide (CO) improved fuel efficiency, and higher red-line RPM resulting in less valve float, substantially lower operating temperatures, increased horsepower, and higher compression ratios allowing for leaner fuel/air mixture. In addition, the six-stroke internal-combustion engine 10 is inexpensive to retool and is adaptable to both new and existing internal-combustion engines, exhibits considerably lower idle speeds, exhibits smoother running with less vibration, and requires less maintenance and service.

Thus the exemplary six-stroke internal-combustion engine is a method to reduce emissions, increase reliability, increase efficiency, operate with various fuels and increase power. The six-stroke internal-combustion engine can be one or multi-cylinder with pistons, with two through five poppet valves per cylinder and have a push-rod, single or dual overhead camshaft system. The six-stroke internal-combustion engine utilizes six strokes which are 1.) the intake stroke, 2.) the compression stroke, 3.) the power stroke, 4.) the exhaust stroke, 5.) the intake-cooling stroke and 6.) the exhaust-cooling stroke. The use of six strokes eliminates exhaust valve overheating, detonation at higher compression ratios, contaminated fuel/air intake with exhaust gases, premature quenching of combustion flame, required intake and exhaust valve overlap, the need for higher octane fuels and harmful high peak combustion temperatures and pressures.

In various embodiments, the six-stroke internal-combustion engine 10 utilizes a single or dual intake manifold and single exhaust manifold per cylinder. The six-stroke internal-combustion engine 10 may also utilize delayed or advanced intake valve openings; delayed or advanced exhaust valve opening; in various combinations, to operate with various fuels whether utilizing throttle body fuel injection; supercharging, turbocharging or low pressure forced air induction; or pulsed direct or port fuel injection with or without supercharging or turbo charging.

In various embodiments of the six-stroke internal-combustion engine 10, several design parameters and variables that affect the combustion process can be adjusted to produce a near perfect and uniform combustion environment inside the combustion chamber to reduce or nearly eliminate unburned hydrocarbons, HC; carbon monoxide, CO; oxides of nitrogen, NOx; particulate and soot exhaust emissions and decrease fuel consumption. Such adjustment allows the use of many types of fuel from low grade blends to hydrogen to increase torque and produce more power while at the same time eliminating most of the detrimental effects of operating an internal-combustion engine at full power over an extended period of time.

In various embodiments, the six-stroke internal-combustion engine 10 provides for a higher compression ratio for a certain octane fuel burned than can be used in a four-stroke cycle engine, therefore the higher compression ratio in a six-stroke cycle engine will result in fewer detonation and pre-ignition problems while burning the same octane fuel as used in the four-stroke cycle engine.

In various embodiments, the six-stroke internal-combustion engine 10 provides a certain timing between the crankshaft and each camshaft so that a three to one ratio exists which allows the camshaft to turn at a slower speed in relationship to crankshaft speed resulting in better valve train control and less valve float at higher engine speeds that a four-stroke cycle engine.

In various embodiments, the six-stroke internal-combustion engine 10 provides an optional staggered or phased opening and closing of the intake valves which causes the fuel/air mixture in each cylinder to be stratified, i.e. richer at the top of the cylinder near the spark plug and leaner at the bottom of the cylinder near the top of the piston; and as an option to be swirled.

In various embodiments, the six-stroke internal-combustion engine 10 provides the opening of the exhaust valves later during the power stroke or near bottom dead center, BDC, allowing longer burn time.

In various embodiments, the six-stroke internal-combustion engine 10 provides a single intake and single exhaust manifold per cylinder or an intake manifold which allows for separate porting of the intake valves per cylinder for an engine with a carburetor.

In various embodiments, the six-stroke internal-combustion engine 10 provides camshafts that are fabricated to allow for the single or multiple valve openings per revolution, with up to two lobes or a long duration lobe actuating each air intake valve and each exhaust valve, e.g., whereby, single lobe may actuate the fuel/air intake valve and two lobes actuate the air intake valve for a carbureted engine or two lobes actuate the fuel/air intake valve or valves for pulsed direct or port fuel injection with or without supercharging, turbocharging or low pressure forced air induction.

In various embodiments, the six-stroke internal-combustion engine 10 includes a single long duration lobe allows the exhaust valve to remain open during the exhaust stroke, the intake-cooling stroke, and the exhaust-cooling stroke and the intake valve to remain open during the intake-cooling stroke, the exhaust-cooling stroke, and the intake stroke for pulsed direct or port fuel injection with supercharging, or turbocharging or low pressure forced air induction. In various embodiments, the single, multiple or long duration lobes can be used in different other combinations.

In various embodiments, the six-stroke internal-combustion engine 10 provides a gap, down to zero gap, instead of overlap with a four-stroke cycle, between the exhaust valve closing and intake valve opening. Therefore, in an exemplary embodiment, the exhaust valve may close near to or before top dead center, BTDC, during the exhaust-cooling stroke and the intake valve may open near to or after top dead center, ATDC, during the intake stroke and the small overlap or gap between exhaust valve closing and intake valve opening will cause less exhaust gas dilution, thereby decreasing emissions, increasing efficiency and increasing power and torque during lower speed operation of the engine,

In various embodiments, the six-stroke internal-combustion engine 10 provides for a cooler combustion chamber and exhaust valves by introducing an air charge during the intake-cooling stroke and exhausting the air charge during the exhaust-cooling stroke. In a typical embodiment, an intake valve may also as an option remain open during the exhaust-cooling stroke creating an air flow from the open intake valve to an open exhaust valve causing additional cooling of the combustion chamber and exhaust valves. Therefore, with a cooler combustion chamber and exhaust valves, the compression ratio can be greatly increased and/or the ignition spark timing can be advanced without detonation or pre-ignition, and in lieu of increasing the compression ratio and/or the ignition spark advance, lower octane fuels can be successfully utilized without detonation or pre-ignition.

In various embodiments, the six-stroke internal-combustion engine 10 provides for a fresh charge of fuel-air during the intake stroke with little or no dilution or contamination with exhaust gases, therefore, this fresh charge of fuel-air will burn more completely, evenly and efficiently with less detonation, pre-ignition, quenching and ignition misfires resulting in less emissions, greater overall efficiency and power with greater reliability.

In various embodiments, the six-stroke internal-combustion engine 10 provides for a reed valve apparatus as an option when necessary to restrict or eliminate any back flow or pressure in the intake and/or exhaust manifolds, whereas the valve apparatus could be any device that only allows gaseous flow in one direction.

These are only a few of the numerous combinations of components that may be used to design a six-stroke cycle internal-combustion engine. In the above description a singular term may also be plural and a plural term may be singular.

We claim:

1. A six-stroke internal combustion engine as herein illustrated and described.
